(19) United States
(12) Patent Application Publication
(10) Pub. No.: US 2020/0377185 A1
(43) Pub. Date: Dec. 3, 2020

(54) DRIVE ASSEMBLY FOR A THRUSTER DRIVE AND THRUSTER DRIVE

(71) Applicant: ZF Friedrichshafen AG, Friedrichshafen (DE)

(72) Inventors: Bernd ZIEGLER, Bad Waldsee (DE); Klemens HUMM, Immenstaad am Bodensee (DE)

(21) Appl. No.: 16/640,583

(22) PCT Filed: Aug. 14, 2018
(86) PCT No.: PCT/EP2018/072009

§ 371 Date: Aug. 17, 2020

(30) Foreign Application Priority Data
Aug. 25, 2017 (DE) 10 2017 214 901.9

(51) Int. Cl. B63H 5/125; B63H 23/04; F16D 3/18

(52) U.S. Cl. CPC B63H 5/125; B63H 23/04; B63H 2023/342; B63H 2005/1256; F16D 3/185

(57) ABSTRACT

A drive assembly for a thruster drive. The drive assembly has a drive shaft that can be connected to a drive motor, an upper deflection gear mechanism, a connecting shaft, a lower deflection gear mechanism and a propeller shaft that can be driven by the lower deflection gear mechanism. The connecting shaft connects the upper deflection gear mechanism to the lower deflection gear mechanism. The connecting shaft is connected to the upper deflection gear mechanism by a first shaft-hub connection and to the lower deflection gear mechanism by a second shaft-hub connection. The first shaft-hub connection has a first hub have a first internal tooth set, which is connected in a form-fitting manner to a first external tooth set of the connecting shaft and to an external tooth set of an output shaft of the upper deflection gear mechanism. At least one of the external tooth sets has a crowning.

This application is a National Stage completion of PCT/EP2018/072009 filed Aug. 14, 2018, which claims priority from German patent application serial no. 10 2017 214 901.9 filed Aug. 25, 2017.

### FIELD OF THE INVENTION

The invention relates to a drive assembly for a thruster drive. In addition the invention relates to a thruster drive with such a drive assembly. Thruster drives are used for driving and maneuvering boats and ships, for example as a bow thruster. Thruster drives are also known by the English term “thruster”.

### BACKGROUND OF THE INVENTION

From EP 2468624 A1 a thruster drive is known, in which the drive power of a main motor is transmitted by way of an upper bevel gear arrangement to a vertically positioned connecting shaft and by way of a lower bevel gear arrangement to a horizontal propeller shaft with a propeller. In this case the upper bevel gear arrangement is attached with an upper transmission unit to the hull of the boat, whereas the lower bevel gear arrangement and the propeller shaft are associated with a lower transmission unit. The lower transmission unit is arranged under the hull of the boat and can pivot. The vertical connecting shaft connects the upper transmission unit to the lower transmission unit. The lower transmission unit with the propeller shaft can pivot about a vertical axis in order to be able to adjust a thrust direction or drive direction of the thruster drive.

### SUMMARY OF THE INVENTION

The purpose of the present invention is to provide a drive assembly designed as simply and compactly as possible for a thruster drive, and a corresponding thruster drive, which ensure reliable operation over as long a useful life as possible.

This objective is achieved by drive assemblies having the characteristics specified in the independent claim(s) and by a thruster drive according to the independent claim(s). Advantageous design features are indicated in the respective dependent claims.

According to these a drive assembly for a thruster drive is proposed, wherein the drive assembly comprises a driveshaft, an upper deflection gearset, a connecting shaft, a lower deflection gearset and a propeller shaft that can be driven by the lower deflection gearset.

The connecting shaft connects the upper deflection gearset to the lower deflection gearset, so that the propeller shaft can be driven, via the upper and lower deflection gearsets, by the driveshaft connected to a drive motor. In this case the connecting shaft is at least approximately vertically orientated and during operation rotates about a vertical axis, whereas the driveshaft and the propeller shaft are orientated horizontally, i.e. they are arranged to rotate about a horizontal axis.

The connecting shaft is connected by means of a first shaft-hub connection to the upper deflection gearset and by means of a second shaft-hub connection to the lower deflection gearset. The first shaft-hub connection comprises a first hub with a first set of internal teeth. The first set of internal teeth is connected with interlock to a first set of external teeth of the connecting shaft and to the external teeth of an output shaft of the upper deflection gearset. The output shaft of the upper deflection gearset, as also the connecting shaft, can rotate about a vertical axis, so that by way of the first hub the output shaft can be connected in a simple manner to the upper end of the vertically orientated connecting shaft. The torque is transmitted by virtue of interlock via the axial internal and external teeth engaged with one another. Suitable teeth are, for example, involute teeth.

At least one of the two sets of external teeth mentioned has crowning. In other words, either the first external teeth of the connecting shaft or the external teeth of the output shaft of the upper deflection gearset have crowning, or both of the external tooth sets have crowning.

Crowning is understood to mean a tooth shape correction in the direction of the tooth width. This reduces the tooth thickness from the middle of the tooth toward the sides to form a convex profile. Thus, in relation to the shafts mentioned and their rotational axes, the tooth thickness changes in the axial direction. The crowning ensures that alignment errors between the components of the drive assembly can be compensated for. Alignment errors may occur in the form of angular deviations or in the form of coaxiality deviations at the shaft-hub connections. These alignment errors are also referred to as angular offsets or radial offsets. Often both types of alignment errors occur at the same time. Such alignment errors can arise during the production and assembly of the components as a result of component tolerances. Furthermore, alignment errors also occur during the operation of a thruster drive due to displacement of the components of the drive assembly under load. The alignment errors can result in large forces, loads and side-surface pressures in the area of the first and second shaft-hub connections, so that there is a risk of tooth flank damage to the teeth and even fracture of the hub concerned.

Thanks to the crowning, the load on the teeth remains approximately at the middle of the tooth concerned despite such alignment errors. Consequently, lateral tooth loads are reduced. Thus, crowning allows larger alignment errors while maintaining central tooth loading. In that way breakdowns due to damage can be avoided and the useful life of the drive assembly can be extended thereby.

In the context of the present invention, an end relief is also to be understood as crowning. An end relief is a correction of the tooth thickness only over part of the tooth width on both sides of the tooth. In this case too the tooth thickness is reduced in the corrected part of the tooth on each side of the tooth. The end relief has an effect similar to that of crowning. In other words, in that way too the tooth loading is reduced so that breakdowns are avoided and the useful life can be extended.

The position expressions “top” or “upper” and “bottom” or “lower” relate to a drive assembly which is fitted into a boat as intended, with the boat lying in calm water. Likewise, the terms horizontal and vertical relate to a boat in calm water and a drive assembly fitted into the boat as intended. The terms vertical and horizontal are understood to be rough directional indications. In other words, they also include arrangements with correspondingly arranged horizontal or vertical components where the position of the components differs from exact horizontality or verticality by a few degrees (up to 10 degrees).

Furthermore another design form of a drive assembly for a thruster drive is proposed, which embodies the same inventive concept. The difference from the first embodiment described is in the arrangement of a vertically aligned drive motor and a vertically aligned driveshaft, whereby the upper deflection gearset can be omitted. The drive assembly according to this further embodiment comprises a vertically aligned drive motor, a vertically aligned driveshaft, a connecting shaft, a lower deflection gearset and a propeller shaft that can be driven via the lower deflection gearset. The connecting shaft connects the vertically aligned driveshaft to the lower deflection gearset. The connecting shaft is connected to the vertical driveshaft by a first shaft-hub connection and to the lower deflection gearset by a second shaft-hub connection. The first shaft-hub connection comprises a first hub with a first set of internal teeth, these internal teeth being connected with interlock to a first set of external teeth of the connecting shaft and to the external teeth of the vertical driveshaft. At least one of the two sets of external teeth has crowning.

The advantageous effects of the crowning are the same in the further embodiment as in the embodiment described first. Preferably, the vertical drive motor is an electric motor, so that a motor shaft of the vertical drive motor forms the vertical driveshaft. In other words, the motor shaft of the electric drive motor is connected directly by the first shaft-hub connection to the connecting shaft. Thus, fewer components are needed than in the embodiment mentioned to begin with. This also achieves the objective of providing a simply designed and compact drive assembly with a long useful life.

The vertically arranged drive motor can be fixed in the hull of the boat, while the lower deflection gearset is arranged in a lower transmission housing which, together with the propeller shaft, can pivot about a vertical axis. By virtue of the pivoting of the lower transmission housing with the propeller shaft, the thrust direction swivels whereby the travel direction of the boat can be changed.

Preferably, in both of the embodiments described above the second shaft-hub connection also comprises a second hub with a second set of internal teeth, such that the second set of internal teeth engage with interlock in a second set of external teeth of the connecting shaft and in a set of external teeth of an input shaft of the lower deflection gearset. The input shaft of the lower deflection gearset is also aligned vertically, so that by way of the second hub it can be connected in a simple manner to the lower end of the likewise vertically aligned connection shaft.

Preferably, in the second shaft-hub connection as well, at least one of the two sets of external teeth has crowning. By virtue of at least one external tooth set with crowning in the first and in the second shaft-hub connection, coaxiality deviations in particular between the output shaft of the upper deflection gearset and the input shaft of the lower deflection gearset can be compensated for. A coaxiality deviation occurs when the output shaft of the upper deflection gearset and the input shaft of the lower deflection gearset are no longer coaxially aligned relative to one another. A coaxial arrangement of the two shafts is the desired basic arrangement. However, this coaxial arrangement is displaced while the boat is under way, for example by forces exerted by the water on the underwater housing of the lower deflection gearset. The two crowned sets of teeth co-operate, for the compensation of radial deviations, together with the connecting shaft in the manner of a cardan coupling. However, the complexity is much reduced by virtue of the present invention than in the case of a conventional cardan coupling involving a multiplicity of components.

In one embodiment it can be provided that only the two external tooth sets of the connecting shaft have the crowning. This embodiment requires the elaborate formation of the crowned teeth to be carried out only on one component, namely the connecting shaft. Despite that, the compensation of deviations described at the upper and lower ends of the connecting shaft, i.e. at the first and second shaft-hub connections, is obtained.

Alternatively, the crowning can also be provided only on the external teeth of the output shaft of the upper deflection gearset and the input shaft of the lower deflection gearset. Thus, the connecting shaft can be made with standard teeth which are simple to produce.

Particularly preferably, it is provided that both sets of external teeth, at the first shaft-hub connection and at the second shaft-hub connection respectively, have crowning. In that way the largest alignment errors or deviations can be compensated for.

The first hub and/or the second hub can in each case be made as integral, essentially tube-shaped bodies. Integral means that each or the hubs is made as only a single piece. The proposed shaft-hub connections therefore only need a force-transmitting additional component, namely the hub.

The external teeth are arranged directly at the shaft ends of the output shaft, the connecting shaft and the input shaft. Instead of hubs with external teeth as with conventional curved-tooth couplings, onto which the shaft ends to be connected have to be arranged, the external teeth are in this case arranged directly at the ends of the shafts so that no separate hubs with external teeth have to be provided. By virtue of the small size of the shaft-hub connections the proposed drive assembly can be made particularly compact and can despite this transmit large torques. Due to its low mass, the drive assembly is also suitable for high rotational speeds. Compared with conventional drive assemblies with conventional shaft-hub connections, the present drive assembly is also characterized by lower wear and higher load-bearing capacity.

The upper deflection gearset can be made as a bevel gear arrangement. In that case the upper deflection gearset comprises an upper, driving bevel gear and an upper, driven bevel gear which are engaged with one another. The upper, driving bevel gear is arranged to rotate about a horizontal axis. The upper, driving bevel gear can be connected to the driveshaft either directly or via a shiftable clutch. The upper, driven bevel gear and the output shaft of the upper deflection gearset are arranged to rotate about the vertical axis. Advantageously, the output shaft of the upper deflection gearset can be made integrally with the upper, driven bevel gear. This design enables a stable and compact structure with fewer individual parts.

The lower deflection gearset as well can be made as a bevel gear arrangement. For this, the lower deflection gearset comprises a lower, driving bevel gear and a lower, driven bevel gear, which are engaged with one another. The input shaft of the lower deflection gearset and the lower, driving bevel gear are arranged to rotate about the vertical axis, whereas the lower driven bevel gear is arranged to rotate about a horizontal axis. Advantageously, the input shaft of the lower deflection gearset can be made integrally with the lower, driving bevel gear in order here as well to produce a stable and compact structure.

Finally, the present invention also includes a thruster drive with a drive assembly according to any of the embodiments described above. In this, the lower deflection gearset is accommodated in a lower transmission housing which, together with the propeller shaft, can be swiveled about a vertical axis. Thanks to the swiveling of the lower transmission housing with the propeller shaft the thrust direction of the propeller pivots, whereby the travel direction of the boat can be changed.

For that purpose the lower transmission housing can be attached to a control tube which, by means of a control drive, can be swiveled about the vertical axis. Advantageously, the first and second shaft-hub connections are accommodated inside the control tube, which makes for a particularly compact structure of the thruster drive.

In the first embodiment of the drive assembly, the upper deflection gearset can be arranged in an upper transmission housing that can be fixed in a boat's hull. The upper transmission housing can for example be fixed firmly or by means of elastic elements for damping vibrations to the boat's hull or to load-bearing components of the boat or the boat's hull.

### BRIEF DESCRIPTION OF THE DRAWINGS

Below, the invention and further advantageous features are explained in greater detail with reference to example embodiments illustrated in the attached figures, which show:

FIG. 1: A thruster drive with a first embodiment of a drive assembly, represented schematically;

FIG. 2: A simplified representation of a first embodiment of the drive assembly for a thruster drive, showing an alignment error in the form of an angle deviation;

FIG. 3: The simply represented drive assembly of FIG. 2, showing an alignment error in the form of a deviation from coaxiality;

FIG. 4: A first embodiment of the drive assembly according to the invention, represented schematically; and

FIG. 5: A second embodiment of the drive assembly according to the invention, represented schematically.

### DETAILED DESCRIPTION OF THE PREFERRED EMBODIMENTS

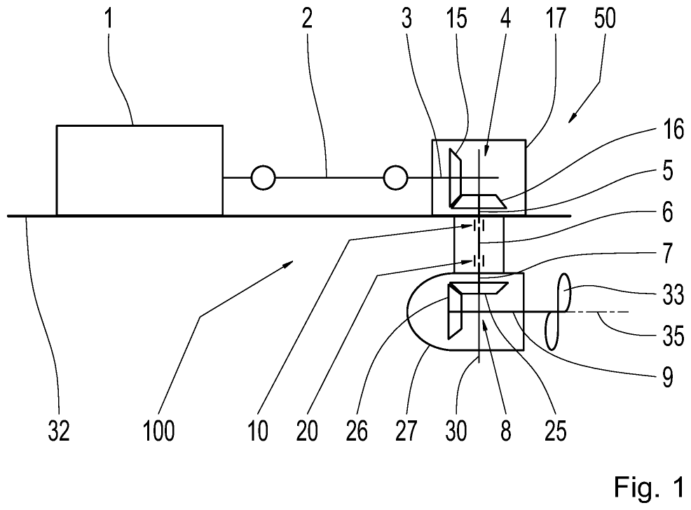

The thruster drive 100 represented in FIG. 1 comprises a drive motor 1 which drives a driveshaft 3 by way of a cardan shaft 2. Instead of the cardan shaft 2, in other embodiments the motor shaft of the drive motor 1 can also be connected directly to the driveshaft 3, via a solid shaft or via a shiftable clutch.

The driveshaft 3 is part of an upper deflection gearset 4, which is fixed in a boat's hull 32. A connection shaft 6 connects the upper deflection gearset 4 to a lower deflection gearset 8, which is arranged underneath the boat's hull 32 and which can pivot relative to the boat's hull 32. By way of the lower deflection gearset 8, a propeller shaft 9 with the propeller 33 fixed thereto can be driven, whereby the associated boat can be driven in the water. By pivoting the lower deflection gearset 8 with the propeller shaft 9 the thrust direction of the propeller 33 and hence the direction of movement of the boat can be changed.

The upper deflection gearset 4 is arranged in an upper transmission housing 17. The upper transmission housing 17 is fixed in the hull 32 of the boat. The upper deflection gearset 4 is in the form of a bevel gear assembly. It comprises an upper, driving bevel gear 15 and an upper, driven bevel gear 16, which are engaged with one another. The upper driving bevel gear 15 is arranged to rotate about a horizontal axis and is connected to the driveshaft 3 in a rotationally fixed manner. The upper driving bevel gear 15 and the driveshaft 3 can also be made integrally. The upper driven bevel gear 16 is arranged to rotate about the vertical axis 30 and is connected rotationally fixed to an output shaft 5 of the upper deflection gearset 4. The output shaft 5 of the upper deflection gearset 4 is connected to the upper end of the connecting shaft 6 by way of a first shaft-hub connection 10.

The lower end of the connecting shaft 6 is connected to an input shaft 7 of the lower deflection gearset 8 by way of a second shaft-hub connection 20. The lower deflection gearset 8 as well is in the form of a bevel gear assembly. It comprises a lower, driving bevel gear 25 and a lower, driven bevel gear 26, which are engaged with one another. In the desired basic arrangement the lower driving bevel gear 25 is arranged to rotate about the vertical axis 30 and is connected rotationally fixed to the input shaft 7 of the lower deflection gearset 8. The lower driving bevel gear 25 and the input shaft 7 can also be made integrally. The lower driven bevel gear 26 is arranged to rotate together with the propeller shaft 9 about the horizontally orientated propeller rotational axis 35.

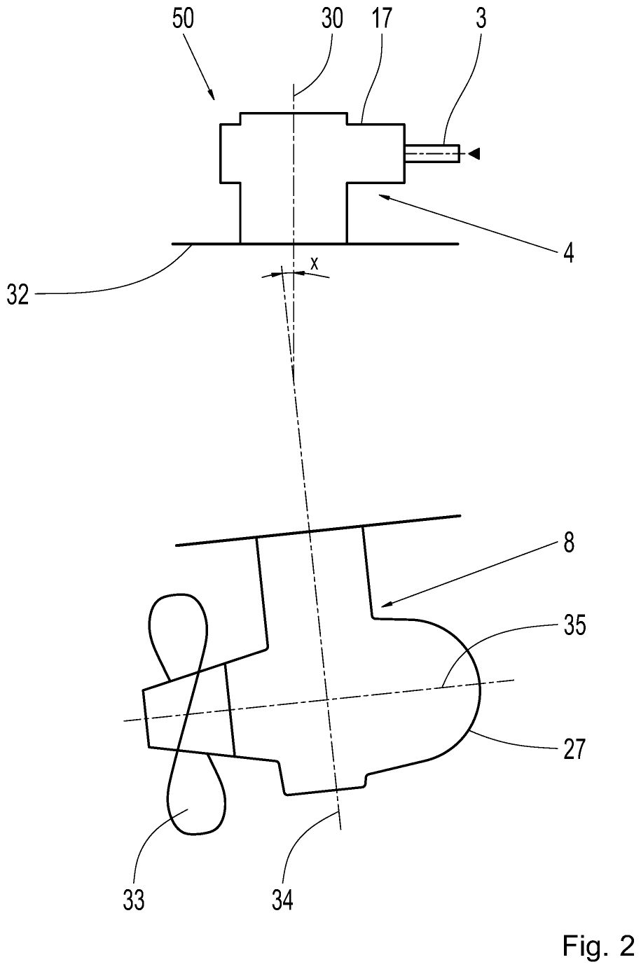

FIG. 2 shows a very simplified representation of a drive assembly 50 for a thruster drive in a boat. In this representation an alignment error in the form of an angle deviation X is shown, which can be compensated for with the help of the present invention. The angle deviation X is produced by a rotation of the lower deflection gearset 8 about a horizontal axis that intersects the propeller rotational axis 35 perpendicularly. With the lower deflection gearset 8, a lower rotational axis 34 is necessarily rotated, about which axis the input shaft 7 of the lower deflection gearset 8 rotates. This produces the angle deviation X of the lower rotational axis 34 relative to the vertical axis 30. The vertical axis 30 is also the rotational axis of the output shaft 5 of the upper deflection gearset 4 fixed in the hull 32 of the boat. The angle deviation X can amount to several degrees and is caused, for example, by component tolerances and/or by displacement under load.

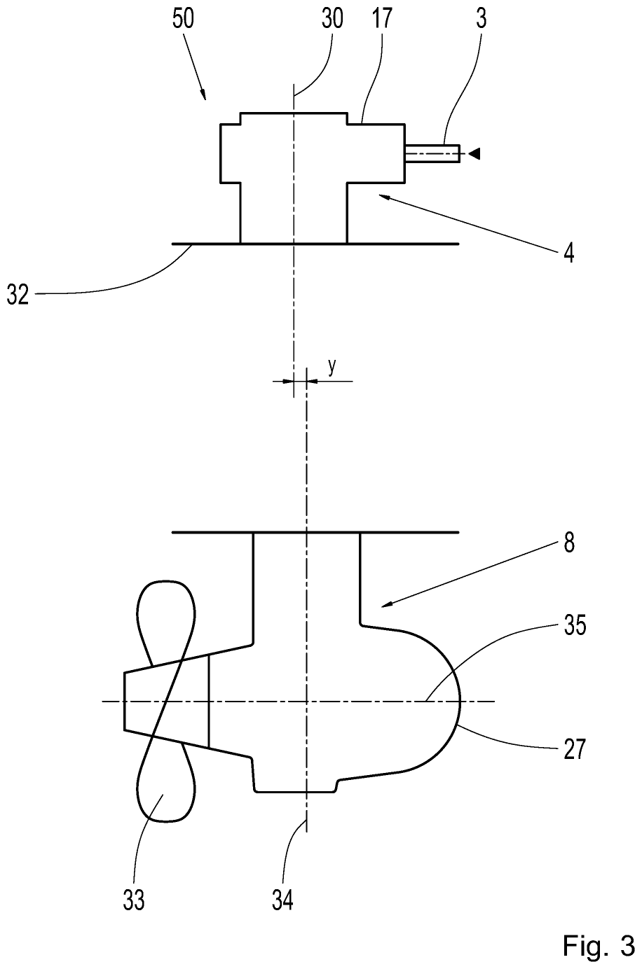

FIG. 3 also shows the greatly simplified representation of the drive assembly 50 for a thruster drive in a boat. In this representation an alignment error in the form of a coaxiality deviation Y is shown, which can also be compensated for with the help of the present invention. The coaxiality deviation Y is produced by displacement of the lower deflection gearset 8 in the direction of the propeller rotational axis 35. With the lower deflection gearset 8, the lower rotational axis 34 is necessarily displaced and the coaxiality deviation Y is produced between the lower rotational axis 34 and the vertical axis 30. In other words, the input shaft 7 of the lower deflection gearset 8 is displaced relative to the output shaft 5 of the upper deflection gearset 4 fixed in the hull 32 of the boat. By virtue of the external teeth 13, 14, 23, 24 in the first and/or the second shaft-hub connection 10 or 20 respectively, such a coaxiality deviation Y too can be compensated for. The coaxiality deviation Y can amount to several millimeters and can also be caused by component tolerances and/or by displacement under load.

When the thruster drive 100 is in operation, the two alignment errors can even occur together so that an angle deviation X and a coaxiality deviation Y co-exist. These combined alignment errors too can be compensated for up to a point with the help of the present invention. In that way stresses in the components can be minimized and the life of the drive assembly can be made longer.

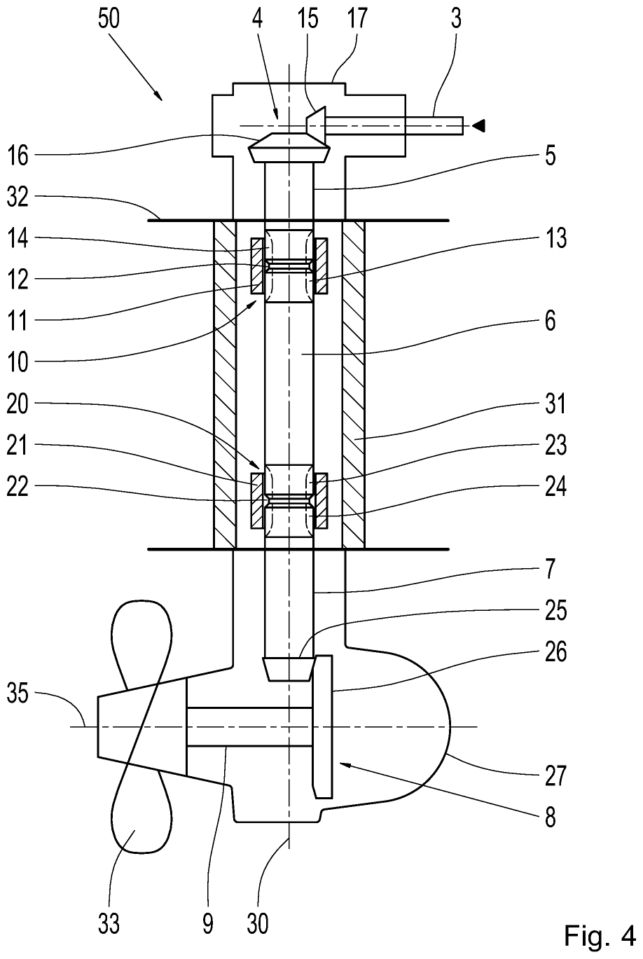

Finally, FIG. 4 shows a drive assembly 50 according to the invention with the upper deflection gearset 4, the lower deflection gearset 8 and with the connecting shaft 6 that connects the two deflection gearsets 4, 8. The propeller shaft 9 is driven by the lower deflection gearset 8 and rotates with the propeller 33 about the propeller rotational axis 35 during operation. The upper and lower deflection gearsets 4, 8 are both in the form of bevel gear assemblies. They each comprise a driving bevel gear 15 or 25 respectively, and a driven bevel gear 16 or 26 respectively, which in each case engage with one another.

The connecting shaft 6 is connected by means of the first shaft-hub connection 10 to the upper deflection gearset 4 and by means of the lower shaft-hub connection 20 to the lower deflection gearset 8. For that purpose the connecting shaft 6 has at its upper end a first set of external teeth 13 and at its lower end a second set of external teeth 23. The first shaft-hub connection 10 comprises a first hub 11 with a first set of internal teeth 12. The first set of internal teeth 12 are connected with interlock to the first external teeth 13 of the connecting shaft 6 and to the external teeth 14 of an output shaft 5 of the upper deflection gearset 4. In this example both of the external tooth sets 13 and 14 have crowning.

The second shaft-hub connection 20 comprises a second hub 21 with a second set of internal teeth 22. The second set of internal teeth 22 are connected with interlock to the second set of external teeth 23 of the connecting shaft 6 and to the external teeth 24 of an input shaft 7 of the lower deflection gearset 8. In this example both of the external teeth sets 23 and 24 have crowning. Thus, in this example embodiment it is provided that in each case the two respective external tooth sets 13, 14, 23 and 24 in the first and second shaft-hub connections 10 and 20 have crowning, in order to be able to compensate for alignment errors as large as possible.

The first hub 11 and the second hub 12 are in both cases integral, tube-shaped bodies with internal teeth 12 or 22 respectively. The two hubs 11 and 12 are the only elements which, in addition to the shaft ends to be connected, form the two shaft-hub connections 10 and 20. An important aspect of the present invention is therefore the simple and compact structure of the drive assembly. Thanks to that, advantageous design freedoms are obtained in the design of the thruster drive.

The lower transmission housing 27 is attached to a control tube 31 which can rotate about the vertical axis 30 in order to thereby change the travel direction of the boat. To rotate the control tube 31, a control device (not shown here) is provided, which for example can be arranged next to the upper deflection gearset 4 in the hull 32 of the boat.

The compact design of the first and second shaft-hub connections 10 and 20 makes it possible to accommodate the two shaft-hub connections 10 and 20 inside the control tube 31, even if the control tube 31 has a comparatively small diameter. This enables a particularly slender and streamlined design of the underwater elements of the thruster drive, which improves the handling characteristics of the boat in water.

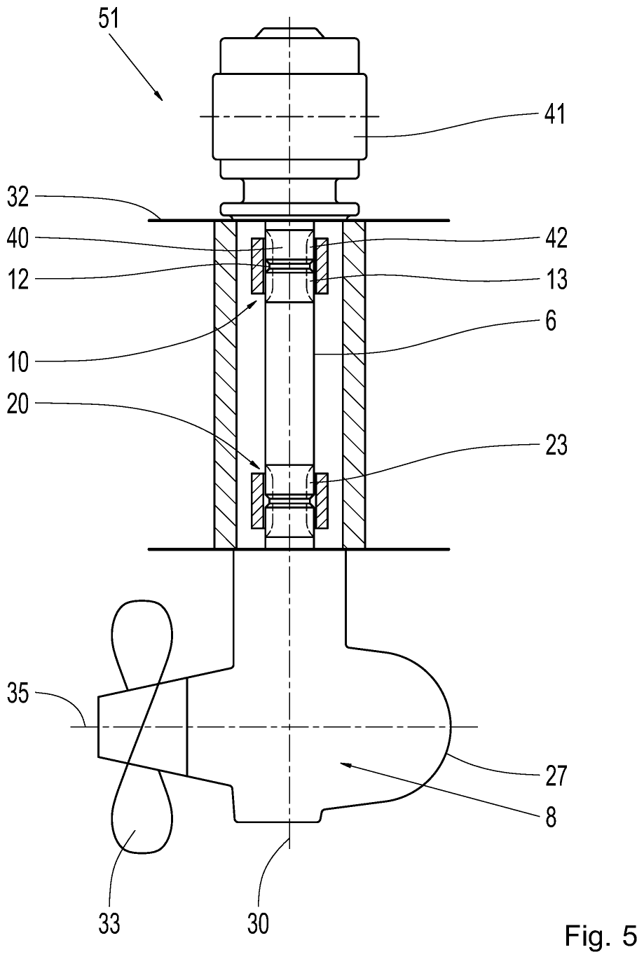

FIG. 5 shows a second embodiment of a drive assembly 51. This differs from the embodiments 50 shown above only in the upper area. All the other components are the same and need not therefore be described again. In this embodiment no upper deflection gearset is provided. Instead, the drive assembly 51 comprises a vertically arranged drive motor 41 and a vertically arranged driveshaft 40, which is connected to the lower deflection gearset 8 by way of the connecting shaft 6. The vertically arranged driveshaft 40 is formed by the motor shaft of the drive motor 41, which is an electric motor. The connecting shaft 6 is connected by means of the first shaft-hub connection 10 to the vertical driveshaft 40 and by means of the second shaft-hub connection 20 to the lower deflection gearset 8. In this case the first shaft-hub connection 10 comprises a first hub 11 with first internal teeth 12, wherein the first internal teeth 12 are connected with interlock to the first external teeth 13 of the connecting shaft 6 and to the external teeth 42 of the vertically arranged driveshaft 40.

In this case the first external teeth 13 of the connecting shaft 6 have crowning, so that here too alignment errors between the components of the drive assembly can be compensated as already described above.

### INDEXES

1 Drive motor
2 Cardan shaft
3 Driveshaft
4 Upper deflection gearset
5 Output shaft
6 Connecting shaft
7 Input shaft
8 Lower deflection gearset
9 Propeller shaft
10 First shaft-hub connection
11 First hub
12 First set of internal teeth
13 First set of external teeth
14 External teeth
15 Upper driving bevel gear
16 Upper driven bevel gear
17 Upper transmission housing
20 Second shaft-hub connection
21 Second hub
22 Second set of internal teeth
23 Second set of external teeth
24 External teeth
25 Lower driving bevel gear
26 Lower driven bevel gear
27 Lower transmission housing
30 Vertical axis
31 Control tube
32 Hull of the boat
33 Propeller
34 Lower rotational axis
35 Propeller rotational axis
40 Vertically arranged driveshaft
41 Vertically arranged drive motor
42 External teeth
50 Drive assembly
51 Drive assembly
100 Thruster drive

1-9. (canceled)

10. A drive assembly for a thruster drive (100), the drive assembly (50) comprising:
a driveshaft (3) that is connectable to a drive motor (1),
an upper deflection gearset (4),
a connecting shaft (6),
a lower deflection gearset (8), and
a propeller shaft (9) that is drivable by the lower deflection gearset (8),
the connecting shaft (6) connecting the upper deflection gearset (4) to the lower deflection gearset (8),
the connecting shaft (6) being connected by a first shaft-hub connection (10) to the upper deflection gearset (4), the connecting shaft (6) being connected by a second shaft-hub connection (20) to the lower deflection gearset (8),
the first shaft-hub connection (10) comprising a first hub (11) with a first set of internal teeth (12), the first set of internal teeth (12) being connected with interlock to a first set of external teeth (13) of the connecting shaft (6) and to an other set of external teeth (14) of an output shaft (5) of the upper deflection gearset (4), at least one of the first and the other sets of external teeth (13, 14) have crowning, the first and the other sets of external teeth (13, 14) being arranged directly at shaft ends of the output shaft (5) and the connecting shaft (6), at least one of the first hub (11) and the second hub (21) are, in each case, in a form of an integral, substantially tube-shaped body, and respective outer diameters of the first and the other sets of external teeth (13, 14) are smaller than or equal to an outer diameter of the connecting shaft (6). 42) are smaller than or equal to an outer diameter of the connecting shaft (6).

11. The drive assembly according to claim 10, wherein the second shaft-hub connection (20) comprises a second hub (21) with a second set of internal teeth (22) such that the second set of internal teeth (22) are connected with interlock to a second set of external teeth (23) of the connecting shaft (5) and to an other set of external teeth (24) of an input shaft (7) of the lower deflection gearset (8), and at least one of the second and the other sets of external teeth (23, 24) has crowning.

12. The drive assembly according to claim 10, wherein in each case the first and the other sets of external teeth (13, 14, 23, 24, 42) in the first shaft-hub connection (10) and in the second shaft-hub connection (20) have crowning.

13. The drive assembly according to claim 10, wherein the upper deflection gearset (4) comprises an upper driving bevel gear (15) and an upper driven bevel gear (16), and the output shaft (5) of the upper deflection gearset (4) is made integrally with the upper driven bevel gear (16).

14. The drive assembly according to claim 10, wherein the lower deflection gearset (8) comprises a lower driving bevel gear (25) and a lower driven bevel gear (26), and the input shaft (7) of the lower deflection gearset (8) is made integrally with the lower driving bevel gear (25).

15. The thruster drive with a drive assembly (50, 51) according to claim 10, wherein the lower deflection gearset (8) is arranged in a lower transmission housing (27) which, together with the propeller shaft (9), is rotatable about a vertical axis (30).

16. The thruster drive according to claim 16, wherein the lower transmission housing (27) is attached to a control tube (31), which is rotatable about the vertical axis (30), and the first shaft-hub connection (10) and the second shaft-hub connection (20) are accommodated inside the control tube (31).

17. The drive assembly for a thruster drive (100), the drive assembly (50) comprising:
a vertically arranged drive motor (41),
a vertically arranged driveshaft (40),
a connecting shaft (6),
a lower deflection gearset (8), and
a propeller shaft (9) that is drivable by the lower deflection gearset (8),
the connecting shaft (6) connecting the vertically arranged driveshaft (40) to the lower deflection gearset (8), the connecting shaft (6) being connected to the vertically arranged driveshaft (40) by a first shaft-hub connection (10), the connecting shaft (6) being connected to the lower deflection gearset (8) by a second shaft-hub connection (20),
the first shaft-hub connection (10) comprising a first hub (11) with a first set of internal teeth (12), the first set of internal teeth (12) being connected with interlock to a first set of external teeth (13) of the connecting shaft (6) and to an other set of external teeth (42) of the vertically arranged driveshaft (40), and at least one of the first and the other sets of external teeth (13, 42) has crowning, the first and the other sets of external teeth (13, 42) being arranged directly at shaft ends of the vertically arranged driveshaft (40) and the connecting shaft (6), at least one of the first hub (11) and the second hub (21) are in a form of an integral, substantially tube-shaped body, and respective outer diameters of the first and the other sets of external teeth (13, 42) are smaller than or equal to an outer diameter of the connecting shaft (6).

18. The drive assembly according to claim 10, wherein the second shaft-hub connection (20) comprises a second hub (21) with a second set of internal teeth (22) such that the second set of internal teeth (22) are connected with interlock to a second set of external teeth (23) of the connecting shaft (5) and to an other set of external teeth (24) of an input shaft (7) of the lower deflection gearset (8), and at least one of the second and the other sets of external teeth (23, 24) has crowning.

19. The drive assembly according to claim 10, wherein in each case the first and the other sets of external teeth (13, 14, 23, 24, 42) in the first shaft-hub connection (10) and in the second shaft-hub connection (20) have crowning.

20. The drive assembly according to claim 10, wherein the upper deflection gearset (4) comprises an upper driving bevel gear (15) and an upper driven bevel gear (16), and the output shaft (5) of the upper deflection gearset (4) is made integrally with the upper driven bevel gear (16).

21. The drive assembly according to claim 10, wherein the lower deflection gearset (8) comprises a lower driving bevel gear (25) and a lower driven bevel gear (26), and the input shaft (7) of the lower deflection gearset (8) is made integrally with the lower driving bevel gear (25).

22. The thruster drive with a drive assembly (50, 51) according to claim 10, wherein the lower deflection gearset (8) is arranged in a lower transmission housing (27) which, together with the propeller shaft (9), is rotatable about a vertical axis (30).

23. The thruster drive according to claim 16, wherein the lower transmission housing (27) is attached to a control tube (31), which is rotatable about the vertical axis (30), and the first shaft-hub connection (10) and the second shaft-hub connection (20) are accommodated inside the control tube (31).
